(19) United States
(12) Patent Application Publication
(10) Pub. No.: US 2009/0115848 A1
(43) Pub. Date: May 7, 2009

(54) MULTIDIRECTIONAL TRAFFIC IMAGE CAPTURING METHOD AND ELECTRONIC POLICE SYSTEM

(75) Inventor: Zhilong LIANG, Beijing (CN)

Correspondence Address: YING CHEN;Chen Yoshimura LLP, 255 S. GRAND AVE., # 215, LOS ANGELES, CA, 90012, US

(73) Assignee: AOCHENGTONGLI S&T DEVELOPMENT ( BEIJING ) CO., LTD, Beijing (CN)

(21) Appl. No.: 11/964,021

(22) Filed: Dec. 25, 2007

(30) Foreign Application Priority Data
Nov. 7, 2007 (CN) 200710166204.2

(51) Int. Cl. H04N 7/18

(52) U.S. Cl. 348/149

(57) ABSTRACT

This invention relates to a multidirectional traffic image capturing method and an electronic police system. This method adopts forward direction camera and side direction camera to capture images of the traffic condition and can obtain qualified images through regularly adjusting the direction of side direction camera with main control unit. This system is made up of main control unit, forward control unit, forward camera, and side control unit and side camera. The main control unit will analyze, judge if there is a disobeying of traffic lights through lights signal and traffic condition, meanwhile control forward direction camera and side direction camera to capture images. This invention adopts multidirectional image capturing method to obtain the images of violated vehicles, which overcomes the long standing issue of red light glaring, guarantees the quality of the images and is mainly used in the supervision and management of the traffic.

### BACKGROUND OF THE INVENTION

1. Field of the Invention

This invention relates to electronic police systems, specifically speaking, a multidirectional traffic image capturing method and an electronic police system to supervise and control the multidirectional image capturing.

2. Description of the Related Art

Present electronic police system applying in road supervision include a supervision camera, shooting camera, a main control unit used to receive, analyze and process the images captured by the supervision camera and the camera control unit used to control the image capturing according to the output of the main control unit; generally the camera is placed along the direction the vehicle running (forward direction in short), that is, located over the back of the crossing or sometimes with a little deviation to capture the backsight images; the position of the vehicle and its back license number will be shown on the image to identify whether it breaking a red light and its license number; the relative brightness of the red light is too large under this shooting method because of the dark background and there will be a large glare on the image captured and/or the video, which may result in the license number unclear even unable to identify, and the credibility will be greatly reduced as basis for enforcement of the law.

### SUMMARY OF THE INVENTION

This invention concerns multidirectional traffic image capturing method and electronic police system. This method adopts forward direction camera and side direction camera to capture images of the traffic condition and can obtain qualified images through regularly adjusting the direction of side direction camera with main control unit. This system is made up of main control unit, forward control unit, forward camera, and side control unit and side camera. The main control unit will analyze, judge if there is a disobeying of traffic lights through lights signal and traffic condition, meanwhile control forward direction camera and side direction camera to capture images. This invention adopts multidirectional image capturing method to obtain the images of violated vehicles, which overcomes the long standing issue of red light glaring, guarantees the quality of the images and is mainly used in the supervision and management of the traffic.

To overcome the deficiency of the above technique, this invention offers a multidirectional traffic image capturing method and an electronic police system to supervise and control the multidirectional image capturing; under this method or system, high quality images can be obtained regardless day or night.

This is a multidirectional traffic image capturing method, which adopts forward direction camera and side direction camera to capture multidirectional images of the traffic condition.

There is angle control device on the side camera to control its turning; the angle control device receives commands from the main control unit to control the side camera; this main control unit can regularly adjust the side camera for auto control image capturing and judge the quality of the image. When the quality fails to meet the requirement, the main control unit will give command to turn the direction of the side camera until qualified images are obtained or the camera is adjusted to the best angle of that moment.

This is an electronic police system of multidirectional traffic image capturing and it contains at least one forward direction camera and one side direction camera.

The effective result of this invention is: the adding of side camera overcomes the long standing red light glare issue on the image, avoids the bad effects caused by red light glare and guarantees the quality of the images; the images of different directions can mutually support and complement each other by sufficiently showing the information of the violated vehicle and is good for avoiding ill-judgment; the problem of unclear license number caused by malicious sheltering when shooting also can be solved by placing counter shootings.

### BRIEF DESCRIPTION OF THE DRAWINGS

FIG. 1 shows the structural scheme of this invention;

FIG. 2 shows the operating mode switching control system of side camera in this invention.

### DETAILED DESCRIPTION OF THE PREFERRED EMBODIMENTS

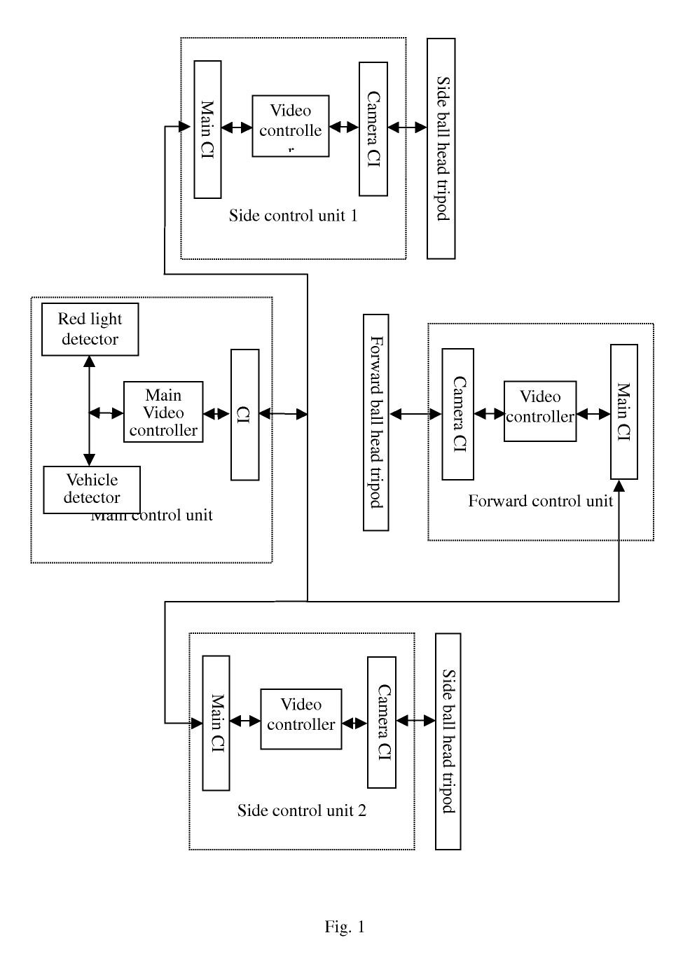

See FIG. 1, the control system of this electronic police system is made up of main control unit, forward direction control unit, the forward direction camera, side direction control unit and the side direction camera; the main control unit will analyze and judge if there is a disobeying of traffic lights through lights signal and traffic condition; if there is any traffic light disobeying, it will input related data (such as the event information, the location of the vehicle and etc.) to the forward control unit and side control unit, who will generate camera capturing data and send to their own forward and side cameras according to related information.

There is also angle control device on the side camera to control its turning; the angle control device receives commands from the main control unit to control the side camera to the commanded angle. This angle can be designed by the program according to the test results, e.g. the curve or diagram between the best side shooting angle and time or hours in a fixed day of certain season can be confirmed according to test results as the basic of adjusting side camera.

The operating process of this invention is as follow:

(1) Red light detector will be employed to take real-time supervision of the red light and the results will be sent to the main video controller.

(2) Vehicle detector will be employed to take real-time supervision on the location and the speed of the forward vehicles and the result will be sent to the video controller.

(3) The red light data and the vehicle location information received by the ARM7 chips of the main video controller will be sampled many times under the principle of picking 3 from 4 to avoid interference and carried out logical judgment; if the vehicle is still running or has passed the restriction line when the forward direction is red light, this is determined as a disobeying, which will be recorded and sent to the forward video controller and the side video controller through the main CI.

(4) After receiving the related information, according to the best ratio data or function for the shooting angle, shooting position, shooting time and environmental condition (optical intensity) inside, the best shooting time, location and the best angle will be determined.

(5) According to the control data sent by the video controller, the forward and side camera will turn to the designed location quickly (the forward camera will not take horizontal rotation), adjust the angle and the aperture of the lens to take photo or video obtaining clear and accurate information.

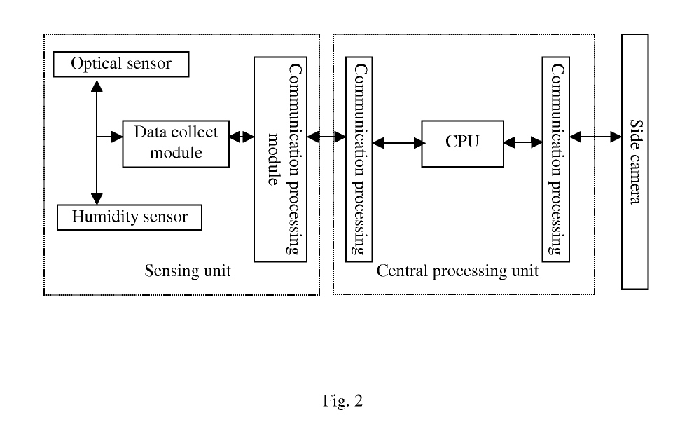

See FIG. 2, in order to improve the image quality, this invention also possesses the operating mode switching control system for the camera to select most suitable model according to the actual environmental conditions. The camera operating mode switching control system includes sensing unit and mode switching control unit; the sensing unit includes data collecting module and several environmental condition sensors; the environmental condition sensors collect real-time information and send them to the data collecting module, which will process those information and generate stable preprocessing environmental condition data; there are CPU (central processing unit) in the mode switching control unit and the CPU will analyze and operate those preprocessing environmental condition data under designed method to obtain the due operating parameters under such environmental condition, generate control command for the camera operation mode and send them to the forward or side camera.

The data collecting module generally adopts single chip.

There is communication processing module for counter communication between the data collecting module and the CPU.

The CPU also can adopt common ARM7 processing unit.

The CPU and the camera adopt RS485 communication protocol; the communication processing module of the mode switching control unit will input the control command to the ball head tripod and will obtain all the present operating parameters of the camera and shooting distances.

What is claimed is:

1. A method for capturing multidirectional traffic image, said method employing forward direction cameras and side direction cameras to capture multidirectional images of the traffic condition.

2. The method of claim 1, wherein there is angle control device to adjust the turning of side cameras. The control device can receive commands from the main control unit to turn the side camera. The main control unit can regularly adjust the side camera for auto control image capturing and judge the quality of the image. When the quality fails to meet the requirement, the main control unit will give command to turn the direction of the side camera until qualified images are obtained or the camera is adjusted to the best angle of that moment.

3. An electronic police system for capturing multidirectional traffic image, said system comprising at least one forward direction camera and one side direction camera.

4. The system of claim 3, wherein said system comprising a main control unit, a forward direction control unit and a side direction control unit. The main control unit will analyze and judge if there is a disobeying of traffic lights through lights signal and traffic condition. If there is any traffic light disobeying, it will input related data to the forward control unit and side control unit, who will generate camera capturing data and send to their own forward and side cameras.

5. The system of claim 4, wherein said main control unit comprising a red light detector, a video controller and a main communication interface (CI) with supervision camera and/or vehicle detector. The forward control unit and the side control unit are mainly made up of main CI, video controller and camera CI. The red light detector will carry out real-time inspection over the red light at present crossing and will send the signal to the main video controller of the main control unit; the supervision camera and/or vehicle detector acquire the real-time traffic information and will send the signal to the main video controller of the main control unit; the main video controller will process the received red light and traffic information after statistic collecting and then carry out logical calculation; once the traffic light disobeying is confirmed, the related information will be immediately sent to the forward video controller of the forward control unit by the main CI as well the side video controller of the side control unit; the best shooting time and the best angle will be calculated according to the best ratio; this data will be sent to the camera through camera CI and the camera will capture images and/or video according to the data.

6. The system of claim 5, wherein said main video controller adopts high performance embedded ARM7 chips; the signals given out by the sensor of the red light detector are digital electrical signals; the signals given out by the sensor of the vehicle detector are also electrical signals; the red light data and the traffic data received by the ARM7 chips of the main video controller will be sampled many times and carried out logical judgment under the principle of picking 3 from 4; if the vehicle is still running or has passed the restriction line when the forward direction is red light, this is determined as a disobeying, which will be recorded and sent to the forward video controller and the side video controller through the main CI; after receiving the related information, according to the best ratio data or function for the shooting angle, shooting position, shooting time and environmental condition inside, the best shooting time and the best angle will be determined, which will be sent to the camera; there are ball head tripod on all the camera.

7. The system of claim 2, wherein said system comprising one or more camera operating mode switching control system, which sends the best operating mode to the corresponding forward or side camera.

8. The system of claim 7, wherein the camera operating mode switching control system includes sensing unit and mode switching control unit; the sensing unit includes data collecting module and several environmental condition sensors; the environmental condition sensors collect real-time information and send them to the data collecting module, which will process those information and generate stable preprocessing environmental condition data; there are CPU (central processing unit) in the mode switching control unit and the CPU will analyze and operate those preprocessing environmental condition data under designed method to obtain the due operating parameters under such environmental condition, generate control command for the camera operation mode and send them to the forward or side camera.

9. The system of claim 8, wherein said environmental condition sensor contains at least one optical sensor, which collects optical intensity sensing information.

10. The system of claim 9, wherein there is a communication processing module for counter communication between the data collecting module and the CPU; the communication processing module is made up of dual parallel port RAM; the CPU and the camera adopt RS485 communication protocol; the communication processing module of the CPU inputs the control command to the ball head tripod and obtains all the present operating parameters of the camera and shooting distances.

11. The system of claim 5, wherein said system comprising one or more camera operating mode switching control system, which sends the best operating mode to the corresponding forward or side camera.

12. The system of claim 11, wherein the camera operating mode switching control system includes sensing unit and mode switching control unit; the sensing unit includes data collecting module and several environmental condition sensors; the environmental condition sensors collect real-time information and send them to the data collecting module, which will process those information and generate stable preprocessing environmental condition data; there are CPU (central processing unit) in the mode switching control unit and the CPU will analyze and operate those preprocessing environmental condition data under designed method to obtain the due operating parameters under such environmental condition, generate control command for the camera operation mode and send them to the forward or side camera.

13. The system of claim 12, wherein said environmental condition sensor contains at least one optical sensor, which collects optical intensity sensing information.

14. The system of claim 13, wherein there is a communication processing module for counter communication between the data collecting module and the CPU; the communication processing module is made up of dual parallel port RAM; the CPU and the camera adopt RS485 communication protocol; the communication processing module of the CPU inputs the control command to the ball head tripod and obtains all the present operating parameters of the camera and shooting distances.

15. The system of claim 6, wherein said system comprising one or more camera operating mode switching control system, which sends the best operating mode to the corresponding forward or side camera.

16. The system of claim 15, wherein the camera operating mode switching control system includes sensing unit and mode switching control unit; the sensing unit includes data collecting module and several environmental condition sensors; the environmental condition sensors collect real-time information and send them to the data collecting module, which will process those information and generate stable preprocessing environmental condition data; there are CPU (central processing unit) in the mode switching control unit and the CPU will analyze and operate those preprocessing environmental condition data under designed method to obtain the due operating parameters under such environmental condition, generate control command for the camera operation mode and send them to the forward or side camera.

17. The system of claim 16, wherein said environmental condition sensor contains at least one optical sensor, which collects optical intensity sensing information.

18. The system of claim 17, wherein there is a communication processing module for counter communication between the data collecting module and the CPU; the communication processing module is made up of dual parallel port RAM; the CPU and the camera adopt RS485 communication protocol; the communication processing module of the CPU inputs the control command to the ball head tripod and obtains all the present operating parameters of the camera and shooting distances.
